(19) United States
(12) Patent Application Publication
(10) Pub. No.: US 2013/0016131 A1
(43) Pub. Date: Jan. 17, 2013

(54) DRIVING METHOD OF MULTI-STABLE DISPLAY

(71) Applicants: Chih-Jen Chen, Tainan City (TW); Chien-Chih Hsu, Miaoli County (TW); Yun-Shuo Chang, Taoyuan County (TW); Cheng-Chung Wu, Taichung City (TW)

(72) Inventors: Chih-Jen Chen, Tainan City (TW); Chien-Chih Hsu, Miaoli County (TW); Yun-Shuo Chang, Taoyuan County (TW); Cheng-Chung Wu, Taichung City (TW)

(73) Assignee: INDUSTRIAL TECHNOLOGY RESEARCH INSTITUTE, Hsinchu (TW)

(21) Appl. No.: 13/183,466

(22) Filed: Jul. 15, 2011

(51) Int. Cl. G09G 5/10; G09G 5/00

(52) U.S. Cl. 345/690

(57) ABSTRACT

A driving method of multi-stable display is provided. A first voltage is provided to a scan line of a pixel if a state of the pixel is not changed. If the pixel is set to a bright state, voltages V2 and V4 are provided to the scan line and a data line in a first phase, and voltages V3 and V5 are provided to the scan and the data lines in a second phase. |V2−V4| and |V3−V5| are smaller than a first threshold voltage. If the pixel is set to a dark state, voltages V2 and V5 are provided to the scan and the data lines in the first phase, and voltages V3 and V4 are provided to the scan and the data lines in the second phase. |V2−V5| and |V3−V4| are greater than a second threshold voltage, and the second threshold voltage is greater than the first threshold voltage.

### BACKGROUND

1. Technical Field

The technical field relates to a display. Particularly, the technical field relates to a driving method of a multi-stable display.

2. Related Art

FIG. 1 is a functional schematic diagram of a conventional passive matrix (PM) bi-stable display 100. The PM bi-stable display 100 includes a data driver 110, a scan driver 120 and a display panel 130. The display panel 130 has a plurality of scan lines S(1), S(2), S(3), S(4), S(5), S(6), . . . , S(N) and a plurality of data lines D(1), D(2), D(3), D(4), . . . , D(M−1), D(M). The scan driver 120 alternately drives the scan lines S(1)-S(N) in a sequence from the scan line S(1) to the scan line S(N). A multi-stable display medium 131 (for example, cholesteric liquid crystal) is disposed between the scan lines and the data lines.

In collaboration with driving timings of the scan lines S(1)-S(N), the data driver 110 correspondingly writes a plurality of pixel data into pixels through the data lines D(1)-D(M). For example, when the scan driver 120 drives the scan line S(1), the data driver 110 correspondingly writes pixel data into a pixel PX through the data line D(M).

FIG. 2 is a reflectivity-voltage characteristic curve diagram of cholesteric liquid crystal. A horizontal axis of FIG. 2 represents a voltage difference (an absolute value) between two electrodes (for example, the scan line S(1) and the data line D(M) of the pixel PX) in a pixel, and a horizontal axis represents light reflectivity of the pixel. A solid line of FIG. 2 represents a characteristic curve of liquid crystal molecules with an initial state of a planner state (or a reflective state, a bright state), and a dot line represents a characteristic curve of liquid crystal molecules with the initial state of a focal conic state (or a non-reflective state, a dark state). If the initial state of the pixel is the bright state (referring to the solid line of FIG. 2), as the voltage difference between the electrodes is increased from VA to VB, the state of the pixel is changed from the bright state to the dark state. If the voltage difference between the electrodes is continually increased, as the voltage difference is increased from VC to VD, the state of the pixel is changed from the dark state to the bright state. If the initial state of the pixel is the dark state (referring to the dot line of FIG. 2), during the process of increasing the voltage difference between the electrodes, the state of the pixel is maintained to the dark state. If the voltage difference between the electrodes is continually increased, as the voltage difference is increased from VC to VD, the state of the pixel is changed from the dark state to the bright state.

Regarding the multi-stable display medium (for example, the cholesteric liquid crystal) display, a right-slope of the reflectivity-voltage characteristic curve is generally used as a threshold for driving the pixels, i.e. a range of the voltage difference (the horizontal axis) of FIG. 2 from VC to VCD is used to drive the pixel. Obviously, the driving voltage of the right-slope is relatively high. For example, the voltage VD is generally 40 volts. Since such high driving voltage is required to be provided, selections of a power module, the data driver 110 and the scan driver 120 have more restrictions. During a process of gray level driving, according to the conventional technique, only a driving voltage (i.e. amplitude modulation (AM)) is adjusted or only a driving time length (i.e. pulse width modulation (PWM)) is adjusted. If the AM is used to implement the gray level driving, the driving system requires multiple driving voltages, and a circuit design thereof is relatively complicated. If the PWM is used to adjust the gray levels, the more the number of the gray levels is, the higher driving frequency the system requires, so that the system has a high power consumption.

### SUMMARY

Accordingly, the disclosure is directed to a driving method of a multi-stable display, by which a driving voltage is effectively reduced to ameliorate a situation of excessive frequency required when a conventional pulse width modulation (PWM) technique is used to control multiple gray levels, and the driving method can be applied to existing STN driver integrated circuits (ICs).

The disclosure provides a driving method of a multi-stable display, which includes following steps. When a state of a pixel is not changed, a first voltage level is provided to a scan line of the pixel. When the state of the pixel is changed, a second voltage level and a third voltage level are respectively provided to the scan line in a first phase and a second phase. When the state of the pixel is set to a bright state, a fourth voltage level and a fifth voltage level are respectively provided to a data line of the pixel in the first phase and the second phase, where an absolute value of a voltage difference of the second and the fourth voltage levels is smaller than a first threshold voltage, and an absolute value of a voltage difference of the third and the fifth voltage levels is also smaller than the first threshold voltage. When the state of the pixel is set to a dark state, the fifth voltage level and the fourth voltage level are respectively provided to the data line in the first phase and the second phase, where an absolute value of a voltage difference of the second and the fifth voltage levels is greater than a second threshold voltage, and an absolute value of a voltage difference of the third and the fourth voltage levels is also greater than the second threshold voltage, and the second threshold voltage is greater than the first threshold voltage.

The disclosure provides a driving method of a multi-stable display, which includes following steps. A second voltage level and a third voltage level are respectively provided to a scan line of a pixel in a first phase and a second phase. A fourth voltage level is provided to a data line of the pixel during a data driving period, and a fifth voltage level is provided to the data line during a period other than the data driving period, where a first part period of the data driving period belongs to the first phase, and a second part period of the data driving period belongs to the second phase, and the fourth voltage level is greater than the fifth voltage level.

According to the above descriptions, since a left-slope of a reflectivity-driving voltage characteristic curve is used to drive pixels, the driving voltage can be effectively reduced. Moreover, in the exemplary embodiment, a gray level of a pixel is controlled by adjusting a phase relationship of pulses of the data line and the scan line, so as to ameliorate a situation of excessive frequency required when the conventional PWM technique is used to control multiple gray levels. The driving method of the multi-sable display of the exemplary embodiment can be applied to the existing STN driver ICs.

In order to make the aforementioned and other features of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a functional schematic diagram of a conventional passive matrix (PM) bi-stable display.

FIG. 2 is a reflectivity-voltage characteristic curve diagram of cholesteric liquid crystal.

FIG. 3 is a diagram illustrating a driving method of a multi-stable display according to an exemplary embodiment.

FIG. 4 is a diagram illustrating a driving method of a multi-stable display according to another exemplary embodiment.

FIG. 5 is a diagram illustrating driving timings of each of scan lines and each of data lines in a pixel array according to an exemplary embodiment.

### DETAILED DESCRIPTION OF DISCLOSED EMBODIMENTS

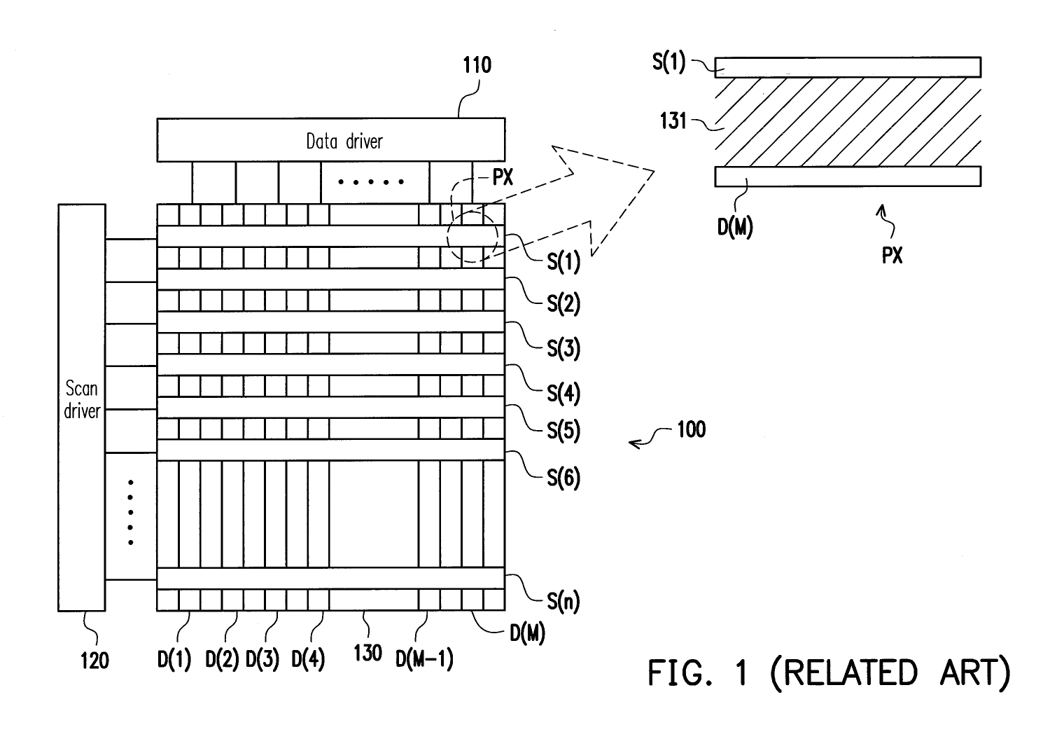

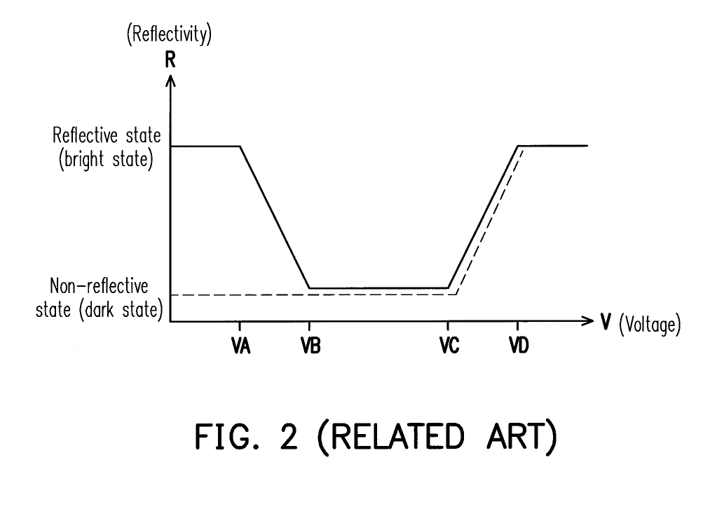

As described in the related art, a driving method of a current multi-stable display generally uses the right-slop (with a range from VC to VD) of the reflectivity-driving voltage characteristic curve of FIG. 2 to drive pixels. In a following embodiment, the pixel PX shown in FIG. 1 is taken as an example for descriptions, and a left-slop (with a range from VA to VB) of the reflectivity-driving voltage characteristic curve of FIG. 2 is used to drive the pixel PX.

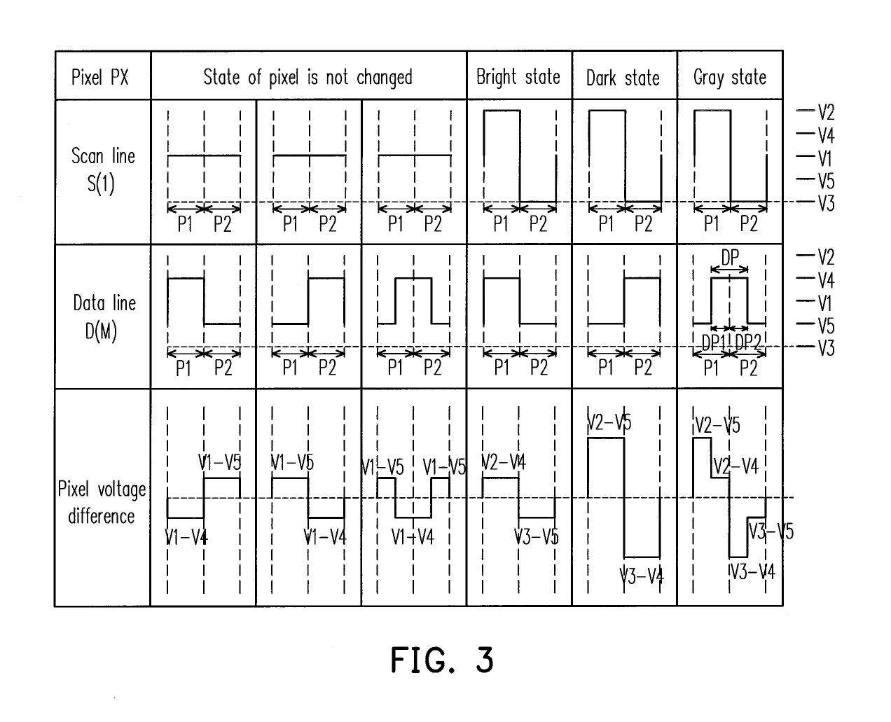

FIG. 3 is a diagram illustrating a driving method of a multi-stable display according to an exemplary embodiment. An initial state of the pixel PX is set to a bright state (a reflective state). Referring to FIG. 3, if the state of the pixel PX is not changed, the scan line S(1) provides a first voltage level V1 to the pixel PX in both of a first phase P1 and a second phase P2. In case that the scan line S(1) is maintained to the first voltage level V1, regardless of a driving waveform provided to the pixel PX by the data line DM(M), since a voltage difference (i.e. |V1−V4| and |V1−V5|) of the bright state pixel PX is not greater than a first threshold voltage VA (referring to FIG. 2), the state of the pixel PX is maintained to the bright state.

If the state of the pixel PX is to be changed to a dark state (a non-reflective state), the scan line S(1) provides a second voltage level V2 to the pixel PX in the first phase P1 and provides a third voltage level V3 to the pixel PX in the second phase P2. The data line D(M) provides a fifth voltage level V5 to the pixel PX in the first phase P1 and provides a fourth voltage level V4 to the pixel PX in the second phase P2, as that shown in FIG. 3. In the first phase P1, an absolute value of a voltage difference of the scan line S(1) and the data line D(M) is |V2−V5|. In the second phase P2, an absolute value of a voltage difference of the scan line S(1) and the data line D(M) is |V3−V4|. Both of the |V2−V5| and |V3−V4| are greater than a second threshold voltage VB (referring to FIG. 2), so that the state of the pixel PX is changed to the dark state.

If the state of the pixel PX is to be changed to the bright state (the reflective state), the scan line S(1) provides the second voltage level V2 to the pixel PX in the first phase P1 and provides the third voltage level V3 to the pixel PX in the second phase P2. The data line D(M) provides the fourth voltage level V4 to the pixel PX in the first phase P1 and provides the fifth voltage level V5 to the pixel PX in the second phase P2, as that shown in FIG. 3. In the first phase P1, an absolute value of a voltage difference of the scan line S(1) and the data line D(M) is |V2−V4|. In the second phase P2, an absolute value of a voltage difference of the scan line S(1) and the data line D(M) is |V3−V5|. Neither of the |V2−V4| and |V3−V5| is greater than a first threshold voltage VA (referring to FIG. 2), so that the state of the pixel PX is changed to the bright state.

In FIG. 3, although it is illustrated that the voltage level V2 is greater than the voltage level V3, it is used as an example, and in other embodiments, the voltage level V2 can be smaller than the voltage level V3. If the state of the pixel PX is to be changed, the absolute value of the voltage difference between the voltage level provided to the pixel PX by the scan line S(1) in the first phase P1 and the voltage level provided to the pixel PX by the data line D(M) in the first phase P1 is required to be greater than the threshold voltage VB, and the absolute value of the voltage difference between the voltage level provided to the pixel PX by the scan line S(1) in the second phase P2 and the voltage level provided to the pixel PX by the data line D(M) in the second phase P2 is required to be greater than the threshold voltage VB.

In the present embodiment, the first voltage level V1, the second voltage level V2, the third voltage level V3, the fourth voltage level V4 and the fifth voltage level V5 are all positive voltages (i.e. greater than or equal to 0 volt). Voltage values of the first voltage level V1, the second voltage level V2, the third voltage level V3, the fourth voltage level V4 and the fifth voltage level V5 can be determined according to an actual design requirement. For example, the first voltage level V1 can be 20 volts, the second voltage level V2 can be 40 volts, the third voltage level V3 can be 0 volt, the fourth voltage level V4 can be 30 volts, and the fifth voltage level V5 can be 10 volts. If the voltage level of 20 volts is provided to the scan line S(1) of the pixel PX in both of the first phase P1 and the second phase P2, the absolute values of the voltage differences of the pixel PX are |20−30| and |20−10|, and neither of |20−30| and |20−10| is greater than the first threshold voltage VA (for example, 10 volts), so that the state of the pixel PX is maintained to the bright state. If the voltage level of 40 volts and the voltage level of 30 volts are respectively provided to the scan line S(1) and the data line D(M) in the first phase P1, the absolute value of the voltage difference of the pixel PX is |40−30|. If the voltage level of 0 volt and the voltage level of 10 volts are respectively provided to the scan line S(1) and the data line D(M) in the second phase P2, the absolute value of the voltage difference of the pixel PX is |0−10|. Regardless of |40−30| or |0−10|, neither of which is greater than the first threshold voltage VA, so that the state of the pixel PX is maintained to the bright state. If the voltage level of 40 volts and the voltage level of 10 volts are respectively provided to the scan line S(1) and the data line D(M) in the first phase P1, the absolute value of the voltage difference of the pixel PX is |40−10|. If the voltage level of 0 volt and the voltage level of 30 volts are respectively provided to the scan line S(1) and the data line D(M) in the second phase P2, the absolute value of the voltage difference of the pixel PX is |10−30|. Regardless of |40−10| or |0−30|, both of which are greater than the second threshold voltage VB (for example, 20 volts), so that the state of the pixel PX is maintained to the dark state.

Under a premise that the scan line S(1) is provided with the aforementioned driving waveforms, in order to change the state of the pixel PX to a gray state, the fourth voltage level V4 is provided to the data line D(M) during a data driving period DP, and the fifth voltage level V5 is provided to the data line D(M) during a period other than the data driving period DP. A part of the data driving period DP (i.e. a first part period DP1 shown in FIG. 3) belongs to the first phase P1, and the remained part of the data driving period DP (i.e. a second part period DP2 shown in FIG. 3) belongs to the second phase P2. Namely, in the present embodiment, a gray level of the pixel PX can be controlled by adjusting a phase relationship of pulses of the data line D(M) and the scan line S(1), so that a situation of excessive frequency required when the conventional pulse width modulation (PWM) technique is used to control multiple gray levels is ameliorated.

In the present embodiment, time lengths of the data driving period DP, the first phase P1 and the second phase P2 are equivalent. In other embodiments, the time lengths thereof can be arbitrarily adjusted according to a design requirement. Moreover, in the present embodiment, the time lengths of the first part period DP1 and the second part period DP2 are equivalent. By adjusting the time length of the data driving period DP, the gray level of the pixel PX can be determined, and the time lengths of the first part period DP1 and the second part period DP2 are not equivalent.

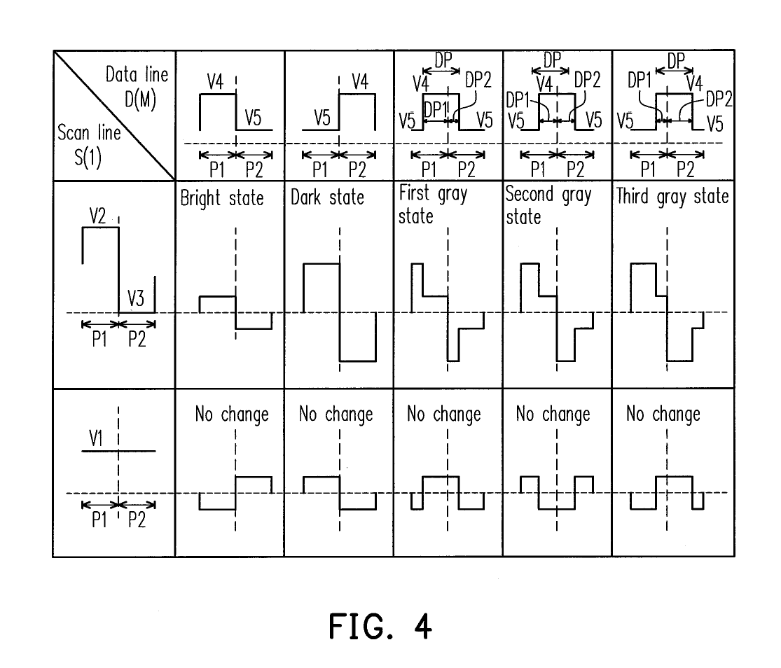

FIG. 4 is a diagram illustrating a driving method of a multi-stable display according to another exemplary embodiment. The driving method of FIG. 4 is similar to that of FIG. 3, and descriptions of the same parts are not repeated. A difference there between is that in the driving method of FIG. 4, the gray level of the pixel PX is determined by adjusting a time length ratio of the first part period DP1 and the second part DP2, i.e. adjusting the phase relationship of the pulses of the data line D(M) and the scan line S(1). As shown in FIG. 4, the time lengths of the first part period DP1 and the second part period DP2 are set to be equivalent, and the reflectivity of the pixel PX (a reflectivity of a second gray state) is an average of the reflectivity of the bright state and the reflectivity of the dark state.

If the phase of the pulse of the data line D(M) is advanced, i.e. the time length of the first part period DP1 is greater than that of the second part period DP2, an average of the voltage difference of the pixel PX is close to the driving voltage of the bright state, so that the reflectivity (reflectivity of a first gray state) of the pixel PX is greater than the reflectivity of the second gray state. If the state of the pixel PX is to be changed to the bright state, the time length of the second part period DP2 is adjusted to be 0 (i.e. the whole data driving period DP belongs to the first phase P1).

Comparatively, if the phase of the pulse of the data line D(M) is postponed, i.e. the time length of the first part period DP1 is smaller than that of the second part period DP2, the average of the voltage difference of the pixel PX is close to the driving voltage of the dark state, so that the reflectivity (reflectivity of a third gray state) of the pixel PX is smaller than the reflectivity of the second gray state. If the state of the pixel PX is to be changed to the dark state, the time length of the first part period DP1 is adjusted to be 0 (i.e. the whole data driving period DP belongs to the second phase P2).

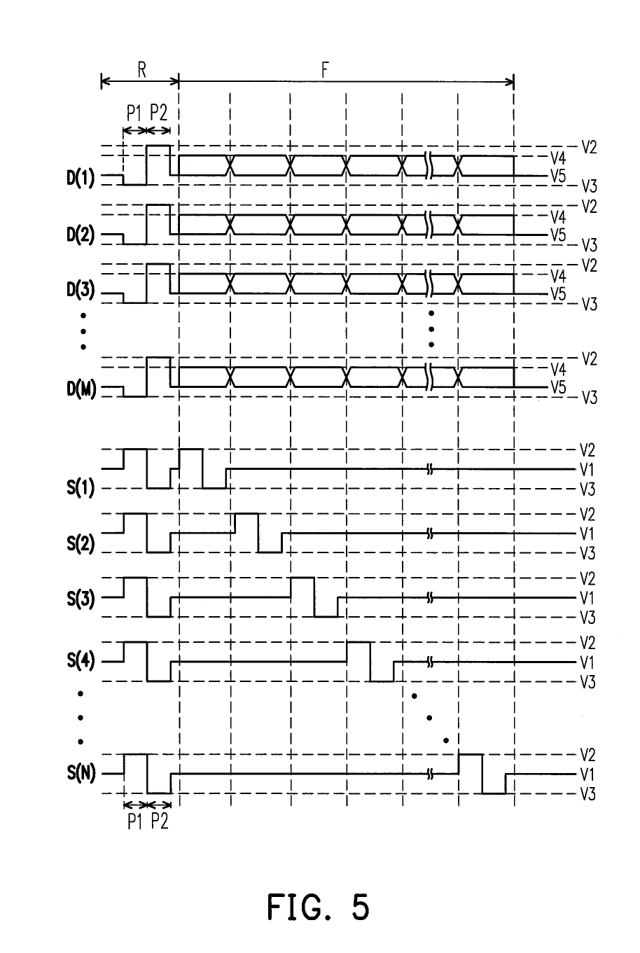

In the above embodiment, one pixel is taken as an example for descriptions. Those skilled in the art can arrange driving timings of the scan lines S(1)-S(N) and the data lines D(1)-D(M) according to the aforementioned instructions. For example, FIG. 5 is a diagram illustrating driving timings of each of the scan lines S(1)-S(N) and each of the data lines D(1)-D(M) in a pixel array according to an exemplary embodiment. During a frame driving period F, the scan driver 120 alternately drives the scan lines S(1)-S(N) in a sequence from the scan line S(1) to the scan line S(N) according to the above disclosed driving method, as that shown in FIG. 5. In collaboration with the driving timings of the scan lines S(1)-S(N), the data driver 110 correspondingly writes a plurality of pixel data into the corresponding pixels through the data lines D(1)-D(M) according to the above disclosed driving method.

In the embodiment of FIG. 5, a reset period R can be arranged before the frame driving period F is started. In the reset period R, all of the pixels in the pixel array are simultaneously reset to the bright state. Here, the pixel PX, the scan line S(1) and the data line D(M) are taken as an example for description, and the other pixels PX, the scan lines and the data lines can be deduced by analogy. If the state of the pixel PX is to be reset, the second voltage level V2 and the third voltage level V3 are respectively provided to the san line S(1) and the data line D(M) in the first phase P1, and the third voltage level V3 and the second voltage level V2 are respectively provided to the san line S(1) and the data line D(M) in the second phase P2.

Voltage values of the second voltage level V2 and the third voltage level V3 can be determined according to an actual design requirement. For example, the second voltage level V2 can be 40 volts, and the third voltage level V3 can be 0 volt. Therefore, in the first phase P1 of the reset period R, the absolute value of the voltage difference of the pixel PX is |40−0|1. In the second phase P2 of the reset period R, the absolute value of the voltage difference of the pixel PX is |0−40|. Regardless of |40−0| or |0−40|, both of which are greater than a fourth threshold voltage VD (referring to FIG. 2, which is, for example, 36 volts). Therefore, all of the pixels in the pixel array are reset to the bright state.

In summary, since the left-slope (with a range from VA to VB) of the reflectivity-driving voltage characteristic curve of FIG. 2 is used to drive pixels, the driving voltage can be effectively reduced. Moreover, in the exemplary embodiment, the gray level of the pixel is controlled by adjusting a phase relationship of the pulses of the data line and the scan line, so as to ameliorate a situation of excessive frequency required when the conventional PWM technique is used to control multiple gray levels. Certainly, the aforementioned embodiment can be combined with the amplitude modulation (AM) and the PWM driving methods of the related art to simultaneously adjust the driving voltage and a duty cycle. The driving method of the multi-sable display of the exemplary embodiment can be applied to the existing STN driver ICs.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

1. A driving method of a multi-stable display, comprising:
when a state of a pixel is not changed, providing a first voltage level to a scan line of the pixel in a first phase and a second phase;
when the state of the pixel is a bright state, respectively providing a second voltage level and a fourth voltage level to the scan line and a data line of the pixel in the first phase, and respectively providing a third voltage level and a fifth voltage level to the scan line and the data line in the second phase, wherein an absolute value of a voltage difference of the second voltage level and the fourth voltage level is smaller than a first threshold voltage, and an absolute value of a voltage difference of the third voltage level and the fifth voltage level is smaller than the first threshold voltage; and
when the state of the pixel is a dark state, respectively providing the second voltage level and the fifth voltage level to the scan line and the data line in the first phase, and respectively providing the third voltage level and the fourth voltage level to the scan line and the data line in the second phase, wherein an absolute value of a voltage difference of the second voltage level and the fifth voltage level is greater than a second threshold voltage, and an absolute value of a voltage difference of the third voltage level and the fourth voltage level is greater than the second threshold voltage, and the second threshold voltage is greater than the first threshold voltage.

2. The driving method as claimed in claim 1, wherein the fourth voltage level is between the second voltage level and the first voltage level.

3. The driving method as claimed in claim 1, wherein the fifth voltage level is between the third voltage level and the first voltage level.

4. The driving method as claimed in claim 1, wherein the first voltage level, the second voltage level, the third voltage level, the fourth voltage level and the fifth voltage level are all greater than or equal to 0 volt.

5. The driving method as claimed in claim 1, further comprising:
when the state of the pixel is to be changed to a gray state, providing the fourth voltage level to the data line during a data driving period, and providing the fifth voltage level to the data line during a period other than the data driving period, wherein one part of the data driving period belongs to the first phase, and a remained part of the data driving period belongs to the second phase.

6. The driving method as claimed in claim 5, wherein the two parts of the data driving period respectively belonged to the first phase and the second phase are respectively a first part period and a second part period, and time lengths of the first part period and the second part period are equivalent.

7. The driving method as claimed in claim 6, further comprising:
adjusting a time length of the data driving period to determine a gray level of the pixel.

8. The driving method as claimed in claim 5, wherein the two parts of the data driving period respectively belonged to the first phase and the second phase are respectively a first part period and a second part period, and time lengths of the first part period and the second part period are not equivalent.

9. The driving method as claimed in claim 5, wherein time lengths of the data driving period, the first phase and the second phase are equivalent.

10. The driving method as claimed in claim 5, further comprising:
adjusting a time length ratio of a first part period and a second part period to determine a gray level of the pixel, wherein the first part period and the second part period are sub periods of the data driving period, and the first part period and the second part period respectively belong to the first phase and the second phase.

11. The driving method as claimed in claim 1, further comprising:
when the state of the pixel is reset, providing the second voltage level to the scan line in the first phase, and providing the third voltage level to the scan line in the second phase; and
when the state of the pixel is reset, providing the third voltage level to the data line in the first phase, and providing the second voltage level to the data line in the second phase.

12. A driving method of a multi-stable display, comprising:
providing a second voltage level to a scan line of a pixel in a first phase;
providing a third voltage level to the scan line in a second phase; and
providing a fourth voltage level to a data line of the pixel during a data driving period, and providing a fifth voltage level to the data line during a period other than the data driving period, wherein a first part period of the data driving period belongs to the first phase, and a second part period of the data driving period belongs to the second phase, and the fourth voltage level is greater than the fifth voltage level.

13. The driving method as claimed in claim 12, wherein time lengths of the first part period and the second part period are equivalent.

14. The driving method as claimed in claim 13, further comprising:
adjusting a time length of the data driving period to determine a gray level of the pixel.

15. The driving method as claimed in claim 12, wherein time lengths of the first part period and the second part period are not equivalent.

16. The driving method as claimed in claim 12, wherein time lengths of the data driving period, the first phase and the second phase are equivalent.

17. The driving method as claimed in claim 12, further comprising:
adjusting a time length ratio of the first part period and the second part period to determine a gray level of the pixel,

18. The driving method as claimed in claim 17, further comprising:
when a state of the pixel is to be changed to a bright state, adjusting a time length of the second part period to 0; and
when a state of the pixel is to be changed to a dark state, adjusting the time length of the first part period to 0.

19. The driving method as claimed in claim 12, further comprising:
when the state of the pixel is not changed, providing a first voltage level to the scan line in the first phase and the second phase, wherein the first voltage level is between the second voltage level and the third voltage level.

20. The driving method as claimed in claim 19, wherein the first voltage level is between the third voltage level and the fourth voltage level, and the first voltage level is between the second voltage level and the fifth voltage level.

21. The driving method as claimed in claim 12, wherein the second voltage level, the third voltage level, the fourth voltage level and the fifth voltage level are all greater than or equal to 0 volt.

22. The driving method as claimed in claim 12, further comprising:
when the state of the pixel is reset, providing the third voltage level to the data line in the first phase, and providing the second voltage level to the data line in the second phase.
